(19) United States
(12) Patent Application Publication
(10) Pub. No.: US 2005/0074989 A1
(43) Pub. Date: Apr. 7, 2005

(54) Power distribution apparatus for a vehicle equipped for trailer towing

(76) Inventor: Donald L Pancheri, South Bend, IN (US)

Correspondence Address: KING & SCHICKLI, PLLC, 247 NORTH BROADWAY, LEXINGTON, KY, 40507, US

(21) Appl. No.: 10/491,769

(22) PCT Filed: Oct. 2, 2001
(86) PCT No.: PCT/US01/30710

(51) Int. Cl. H01R 33/00

(52) U.S. Cl. 439/35

(57) ABSTRACT

A power distribution apparatus includes a 4-way power inlet and/or a 7-way power inlet, a 4-way power outlet and/or a 7-way power outlet, a utility power outlet and electrical conductors for completing the connection.

### TECHNICAL FIELD

The present invention relates generally to accessories for motor vehicles and, more particularly, to a power distribution apparatus for providing electrical power between a towing vehicle and a trailer being towed and/or an electrical accessory requiring 12 volt power.

### SUMMARY OF THE INVENTION

It has long been known to construct towing hitches that are mounted to vehicles in order to allow the towing of trailers or the like. In recent years such hitches have been designed to include a receiver box having a rearwardly directed opening or cavity for the receipt of a hitch or draw bar that carries a hitch ball or other means allowing connection to a trailer. Examples of such a structure include the Insta-Hitch II and Custom Hitch Receiver 35365 as manufactured by Reese Products, Inc. of Elkhart, Ind. Such a hitch receiver is also disclosed in, for example, U.S. Pat. No. 3,768,837 to Reese.

Recent efforts to enhance the versatility of a hitch receiver have led to development of various accessories (e.g., both open and closed article carriers, bike racks, ski racks, tables, winches or other equipment) mounted by means of an accessory mounting bar in the receiver box of a trailer hitch receiver assembly. Because of their convenience and suitability to the particular applications/interests of the user, such accessories have become very popular.

In order to allow for or accommodate trailer towing and accessory mounting simultaneously, a trailer hitch assembly with both a trailer hitch receiver and towing accessory receivers has been recently developed and is the subject of U.S. Patent Application Ser. No. 60/194,502, filed Apr. 3, 2000 and 60/243,486 filed Oct. 26, 2000. This new trailer hitch receiver assembly includes a central frame member, a mounting bracket carried on each end of the central frame member for securing the central frame member to the vehicle, a hitch receiver box carried on the central frame member and at least one accessory receiver for receiving and holding a recreational and/or utilitarian accessory.

Many useful accessories, such as the utility light illustrated and described in detail in U.S. Provisional Patent Application Ser. No. 60/243,484 filed Oct. 26, 2000, require 12-volt electrical power for proper operation. The present invention relates to a power distribution system particularly adapted for distributing power from the towing vehicle to the electrical operating systems of the trailer (i.e. taillights, turn indicator lights, brake lights and electrical trailer brakes) and/or a utilitarian accessory requiring 12-volt power for operation.

### SUMMARY OF THE INVENTION

In accordance with the purposes of the present invention as described herein, a power distribution apparatus is provided for a tow vehicle. In one embodiment of the invention, the power distribution apparatus comprises a 4-way power inlet, a 4-way power outlet, a 12-volt utility power outlet and electrical conductors operatively connecting the 4-way power inlet to the 4-way power outlet and the utility power outlet.

The power distribution apparatus may take the form of a simple wiring harness or it may further include a housing carrying the 4-way power inlet, the 4-way power outlet, the utility power outlet and the electrical conductors. That housing may be mounted directly to the towing vehicle, such as to the frame or bumper, or indirectly to the towing vehicle through a cross member, mounting bracket or other element of a receiver assembly.

Toward this end the housing may include at least one mounting tab having an aperture. Additionally, the apparatus includes a fastener for passing through the aperture and securing the apparatus to the tow vehicle. Additionally, the apparatus may include a fuse in one of the electrical conductors between the 4-way power inlet and the utility power outlet.

In accordance with another embodiment of the present invention, the power distribution apparatus for a tow vehicle may comprise a 7-way power inlet, a 7-way power outlet, a 12-volt utility power outlet and electrical conductors operatively connecting the 7-way power inlet to the 7-way power outlet and the utility power outlet.

As noted above with respect to the first embodiment, the apparatus may comprise a simple wiring harness. Alternatively, the apparatus may include a housing that carries the 7-way power inlet, the 7-way power outlet, the utility power outlet and the electrical conductors. Like the housing described above that housing may include at least one mounting tab having a mounting aperture. The apparatus may also include a fastener for passing through the aperture and securing the apparatus either directly or indirectly to the tow vehicle. Similarly, a fuse may also be provided in one of the electrical conductors between the 7-way power inlet and the utility power outlet.

In still another embodiment of the present invention, a power distribution apparatus for a tow vehicle comprises a 4-way power inlet, a 7-way power inlet, a 4-way power outlet, a 7-way power outlet, a 12-volt utility power outlet and electrical conductors operatively connecting (a) the 4-way power inlet to the 4-way power outlet and the utility power outlet and (b) the 7-way power inlet to the 7-way power outlet and the utility power outlet.

As noted above with respect to the other embodiments, this third embodiment may take the form of a wiring harness or alternatively include a housing that carries the various components of the invention. That housing may include at least one mounting tab having an aperture. The apparatus may further include a fastener for passing through the aperture and securing the apparatus either directly or indirectly to the tow vehicle. Additionally, the apparatus of the third embodiment may include a fuse in one of the electrical conductors between the 4-way and 7-way power inlets and the utility power outlet.

In the following description there is shown and described several preferred embodiments of the present invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention and together with the description serve to explain the principles of the invention. In the drawings:

FIG. 1 is a top plan view showing a first embodiment of the present invention;

FIG. 2 is a top plan view showing a second embodiment of the present invention;

FIG. 3 is a perspective view showing a third embodiment of the present invention;

FIG. 4 is a left side elevational view of the embodiment of the present invention shown in FIG. 3;

FIG. 5 is a schematical wiring diagram of the embodiment of the invention shown in FIGS. 3 and 4; and

FIG. 6 is a perspective view showing a utility light mounted on a trailer hitch receiver assembly carrying the power distribution apparatus of the present invention.

Reference will now be made in detail to the present preferred embodiments of the invention, examples of which are illustrated in the accompanying drawings.

### DETAILED DESCRIPTION OF THE INVENTION

Reference is now made to FIG. 1 showing a first embodiment of the power distribution apparatus of the present invention generally designated by reference numeral 10. As illustrated, the power distribution apparatus 10 includes a 4-way power inlet 12, a 4-way power outlet 14, a 12-volt utility power outlet 16 and electrical conductors 18a-f. As should be appreciated, in the illustrated embodiment the 4-way power inlet 12, 4-way power outlet 14 and 12-volt utility power outlet 16 assume the form of standard electrical power plugs. It, of course, should be appreciated that such plugs are only shown for purposes of illustration and that substantially any power inlet and outlet structures may be utilized so long as they are appropriate for the intended purpose.

As should be appreciated, the power distribution apparatus 10 is specially adapted for use with a towing vehicle equipped with a standard 4-way power outlet plug (not shown). In use, the 4-way power inlet 12 is connected to the 4-way power outlet of the towing vehicle. The electrical conductor 18a is the ground line. The electrical conductor 18b is the taillight line. The electrical conductor 18c is the left turn signal line. The electrical conductor 18d is the right turn signal line. The electrical conductor 18e is the ground feed to the utility power outlet 16 while the electrical conductor 18f is the power feed to the utility power outlet which taps power from the taillight line. A fuse (not shown) may be provided in power feed line/electrical conductor 18f if desired.

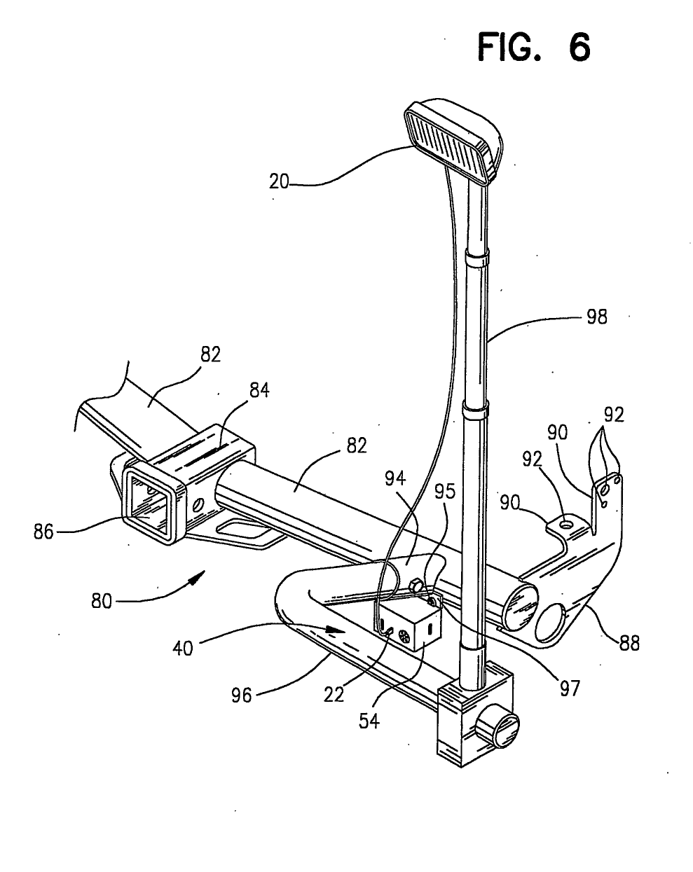

As noted above, the 4-way power inlet 12 connects with a cooperating power outlet or plug provided on the tow vehicle. Similarly, the 4-way power outlet 14 interconnects with a cooperating standard plug or inlet provided on a trailer. The electrical conductors 18a-18d carry the power between the inlet 12 and outlet 14 thereby providing a bridge between the power outlet on the towing vehicle and the power inlet of the trailer. In this way the electrical operating systems of the trailer including the taillights, brake lights and turn indicator lights are all powered for proper operation. Additionally, a useful accessory, such as the utility light shown in FIG. 6 and generally designated by reference numeral 20 may be powered through the 12-volt utility power outlet 16. More specifically, a cooperating inlet plug 22 on the utility light 20 is connected with the 12-volt utility power outlet 16. The taillights of the towing vehicle are energized to provide power through the electrical conductor 18f so that the electrical connection is completed from the towing vehicle, through the towing vehicle power outlet, the 4-way power inlet 12, the electrical conductors 18e (ground), 18f, the 12-volt utility power outlet 16 and the power inlet plug 22 of the utility light 20. Accordingly, 12-volt power is provided to the utility light which then functions to illuminate the surroundings.

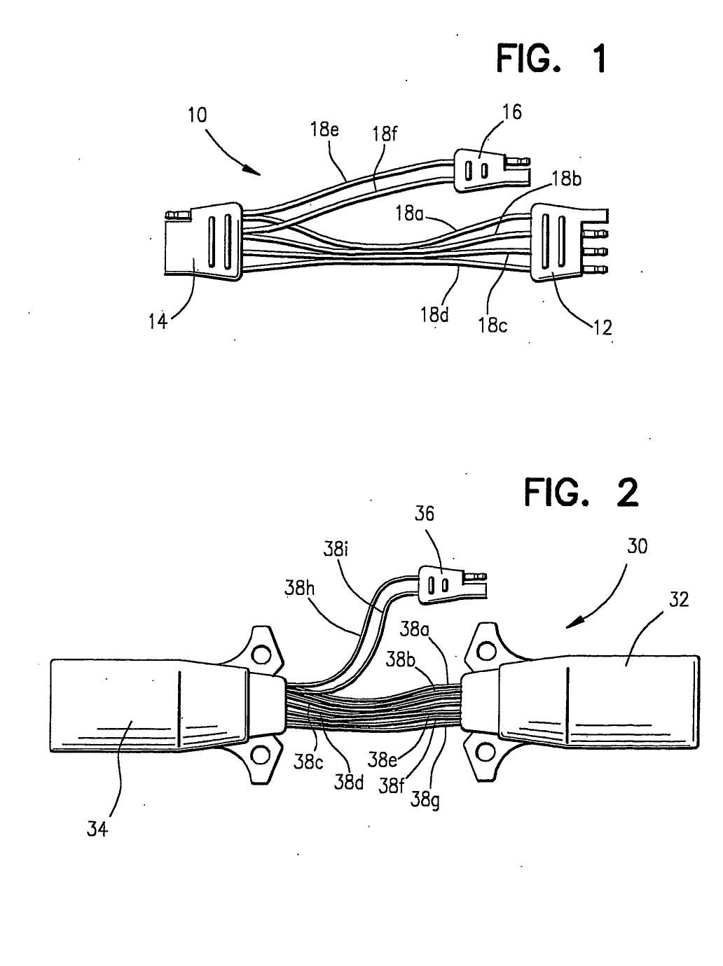

An alternative embodiment of the present invention 30 is shown in FIG. 2. The power distribution apparatus 30 includes a 7-way power inlet 32, a 7-way power outlet 34, a 12-volt utility power outlet 36 and a group of electrical conductors 38a-38i. As illustrated in FIG. 2, the 7-way power inlet 32 and 7-way power outlet 34 take the form of standard 7-way plugs commonly utilized for trailer towing. It should be appreciated, however, that other mating electrical terminals could be utilized and still provide the intended function. Similarly, the 12-volt utility outlet 36 may take the form of the standard plug illustrated or any other appropriate arrangement useful for the intended purpose.

As shown, the electrical conductors 38a-i interconnect the 7-way power inlet 32 with the 7-way power outlet 34 and the utility outlet 36. More specifically, electrical conductor 38a is a ground. Electrical conductor 38b is a 12-volt power line. Electrical conductor 38c is a left-turn signal line. Electrical conductor 38d is an auxiliary line. Electrical conductor 38e is a taillight line. Electrical conductor 38f is an electrical trailer brake line. Electrical conductor 38g is a right-turn signal line. Electrical conductor 38h is a ground feed line for the utility outlet 36 while electrical conductor 38i is a 12-volt power feed line for the utility outlet 36. A fuse (not shown) may be provided in the power feed line/electrical conductor 38i if desired.

In use, the 7-way power inlet 32 of the power distribution apparatus 30 is connected or plugged into the standard 7-way power outlet provided on the towing vehicle. In order to power the electrical systems of a trailer, the 7-way outlet 34 is connected to the cooperating standard 7-way plug with which the trailer is equipped. In this way power flows from the towing vehicle through the apparatus 30 to the trailer so as to provide the desired power to the electrical operating systems of the trailer including the turn signals, brake lights, taillights and electrical trailer brakes. Of course, it should be appreciated that the apparatus 30 could just as easily be equipped with a 4-way power output plug just as shown at 14 in the first embodiment to allow for conversion from a 7-way system on the tow vehicle to a 4-way system on a trailer if required for any particular application.

Additionally, an electrical accessory such as the utility light 20 shown in FIG. 6 may be powered through the utility outlet 36. More specifically, the standard inlet plug 22 carried on the utility light 20 is connected with the 12-volt utility outlet 36. This connection serves to provide power from the towing vehicle through the apparatus 30 and more particularly, the power inlet 32, electrical conductors 38h and 38i and the utility outlet 36 to the utility light 20. Thus, by means of this connection the utility light 20 is powered and may be utilized to illuminate the surrounding area.

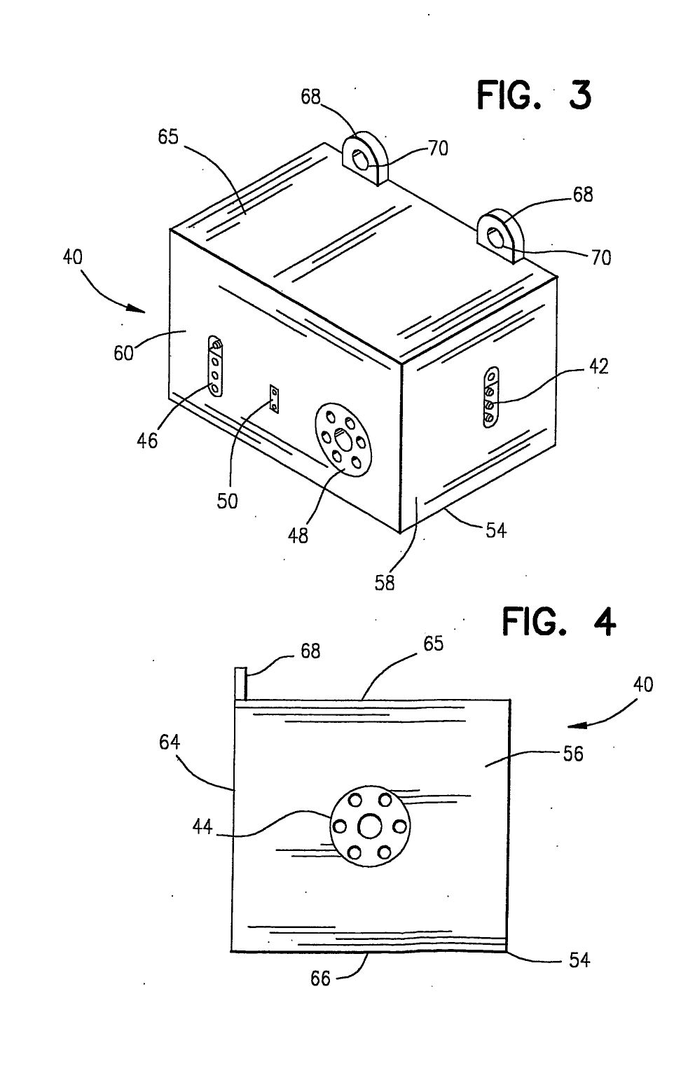

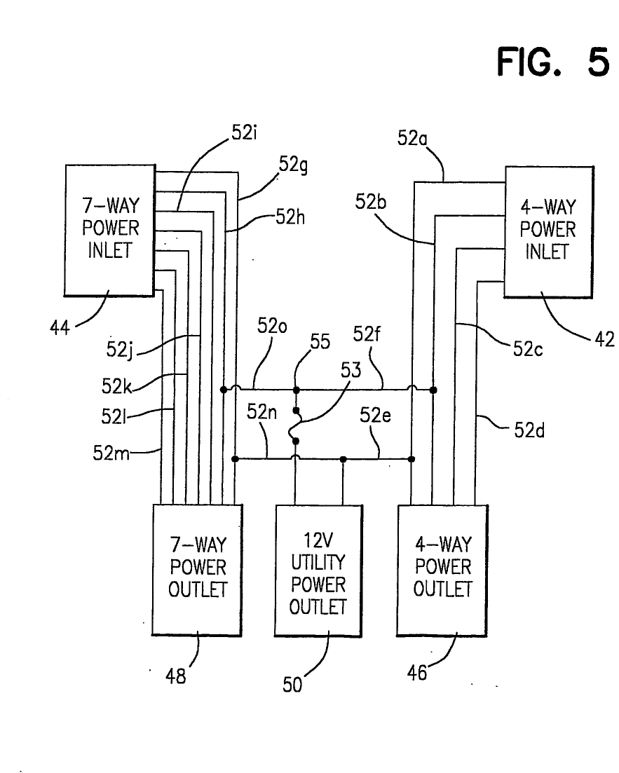

Up to this point in time, the two illustrated embodiments have taken the form of wiring harnesses. Reference is now made to FIGS. 3-5 showing a third embodiment of the power distribution apparatus 40 of the present invention. The apparatus 40 includes a 4-way power inlet 42, a 7-way power inlet 44, a 4-way power outlet 46, a 7-way power outlet 48 and a 12-volt power outlet 50. Electrical conductors 52a-52d provide proper interconnection of the 4-way inlet 42 with the 4-way outlet 46 in the same manner described above for the electrical conductors 18a-18d of the first embodiment 10 of the present invention. The electrical conductors 52e and 52f provide proper interconnection of the 4-way inlet 42 with the 12-volt power outlet 50 in the same manner as electrical conductors 18e and 18f of the first embodiment of the power distribution apparatus 10.

Similarly, the electrical conductors 52g-52m provide proper interconnection of the 7-way power inlet 44 with the 7-way power outlet 48 in the manner described above with respect to the electrical conductors 38a-38g of the second embodiment of the apparatus 30. Likewise, the electrical conductors 52n and 52o provide proper interconnection between the 7-way power inlet 44 and the 12-volt power outlet 50 in the same manner that the electrical conductors 38h and 38i provided that interconnection in the second embodiment of the apparatus 30. Again, a fuse such as illustrated at reference numeral 53 may be provided in the power line feed leading to the utility outlet 50 between the connection point 55 of the electrical conductors 52f and 52o and the utility outlet.

As further shown in FIGS. 3 and 4, this apparatus 40 includes a box like housing 54 that holds all of the components of the apparatus. As illustrated, the 7-way power inlet 44 is mounted and held in the side wall 56, the 4-way power inlet 42 is mounted and held in the side wall 58 and the 4-way power outlet 46, 7-way power outlet 48 and 12-volt power outlet 50 are all mounted and held in the wall 60. The electrical conductors 52a-52o are all contained within the housing enclosure. While not clearly illustrated, it should be appreciated that one of the walls 64-66 is provided in the form of a removable cover to allow access to the enclosure for purposes of installation and maintenance of the various inlets, outlets and conductors. The cover preferably forms a weather-tight seal with the remaining walls of the housing 54.

As further shown in FIGS. 3 and 4, the housing 54 includes a pair of mounting tabs or lugs 68. Each tab/lug 68 includes an aperture 70. A fastener passes through each aperture and may be utilized to secure the apparatus 40 directly to the bumper, frame or other component of the tow vehicle. Substantially any form of fastener may be utilized including but not limited to screws, bolts with cooperating lock nuts and tie straps of plastic, metal or other appropriate material.

As shown in FIG. 6, the apparatus 40 could also be secured indirectly to the towing vehicle through the receiver assembly generally designated by reference numeral 80. As illustrated, that receiver assembly 80 includes a cross member 82 that carries a centrally located receiver box 84. The receiver box 84 includes a hitch bar receiving cavity 86 for receiving and holding a hitch bar or draw bar (not shown) for towing a trailer. The receiver assembly 80 also includes mounting brackets 88 adjacent the distal ends thereof (only one shown in the figure). The mounting brackets 88 include mounting flanges and lugs 90 provided with apertures 92. Nut and bolt fasteners (not shown) are extended through these apertures 92 and cooperating apertures drilled in the frame of the towing vehicle in order to mount the trailer hitch receiver assembly 80 thereto.

As shown in FIG. 6, the power distribution apparatus 40 of the present invention is secured to the cross member 80 by means of cooperating bolt and nut fasteners 95 secured through the apertures 70 in the tabs 68 and a mounting plate 97 welded to the cross member 82. As noted above, however, other appropriate fasteners including cooperating screws and tie straps could be utilized for this purpose. By mounting the apparatus 40 in this position, it is conveniently located to allow an operator to interconnect the power plug from the tow vehicle into the matching 4-way or 7-way inlets 42, 44 of the apparatus and the power plug of the trailer to the matching 4-way or 7-way power outlets 46, 48 of the apparatus. Additionally, the 12-volt power outlet 50 is also readily accessible for interconnection to an accessory such as the utility light 20.

As shown, that utility light 20 includes a telescoping post 98 and a mounting end 96 received and secured in an accessory receiver 94 carried on the cross member 82 of the trailer hitch receiver assembly 80. While a utility light 20 is illustrated, it should be appreciated that substantially any other useful accessory requiring 12-volt power may be interconnected and powered through any one of the illustrated apparatus 10, 30, 40 of the present invention.

In summary, numerous benefits result from employing the concepts of the present invention. The first embodiment of the apparatus 10 allows one to quickly and easily connect a standard 4-way power plug on a tow vehicle with either or both a similarly equipped trailer and a useful 12-volt electrically powered accessory 20. The second embodiment of the apparatus 30 provides the same advantages for individuals with vehicles and trailers equipped with a 7-way electrical system. The third embodiment of the apparatus 40 is the most versatile. It allows operation with either a 4-way or 7-way system. This is particularly useful for individuals that (1) utilize their vehicles to tow different trailers where some of those different trailers are equipped with a 4-way system while others are equipped with a 7-way system or (2) utilize their receiver assembly on two different towing vehicles where one is equipped with a 4-way system and the other a 7-way system.

The foregoing description of the preferred embodiments of the present invention have been presented for purposes of illustration and description. It is not intended to be exhaustive or to limit the invention to the precise form disclosed. Obvious modifications or variations are possible in light of the above teachings. For example, the FIG. 1 and FIG. 2 embodiments 10, 30 are illustrated as wiring harnesses but could just as easily incorporate a full housing enclosure as illustrated with respect to the third embodiment 40. Likewise, the third embodiment 40, illustrated with a fully enclosed housing 54 could take the form of a wiring harness without any housing such as illustrated for the FIGS. 1 and 2 embodiments. It should also be appreciated that the third embodiment 40 could be wired for converting a 7-way standard outlet plug on the towing vehicle to a 4-way standard inlet plug on a trailer.

The embodiments were chosen and described to provide the best illustrations of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A power distribution apparatus for a tow vehicle, comprising
a 4-way power inlet;
a 4-way power outlet;
a utility power outlet; and
electrical conductors operatively connecting said 4-way power inlet to said 4-way power outlet and said utility power outlet.

2. The apparatus of claim 1, further including a housing carrying said 4-way power inlet, said 4-way power outlet, said utility power outlet and said electrical conductors.

3. The apparatus of claim 2, wherein said housing further includes at least one mounting tab.

4. The apparatus of claim 3, wherein said at least one mounting tab includes an aperture.

5. The apparatus of claim 4, further including a fastener for passing through said aperture and securing said apparatus to the tow vehicle.

6. The apparatus of claim 5, further including a fuse in one of said electrical conductors between said 4-way power inlet and said utility power outlet.

7. A power distribution apparatus for a tow vehicle, comprising
a 7-way power inlet;
a 7-way power outlet;
a utility power outlet; and
electrical conductors operatively connecting said 7-way power inlet to said 7-way power outlet and said utility power outlet.

8. The apparatus of claim 7, further including a housing carrying said 7-way power inlet, said 7-way power outlet, said utility power outlet and said electrical conductors.

9. The apparatus of claim 8, wherein said housing further includes at least one mounting tab.

10. The apparatus of claim 9, wherein said at least one mounting tab includes an aperture.

11. The apparatus of claim 10, further including a fastener for passing through said aperture and securing said apparatus to the tow vehicle.

12. The apparatus of claim 11, further including a fuse in one of said electrical conductors between said 7-way power inlet and said utility power outlet.

13. A power distribution apparatus for a tow vehicle, comprising:
a 4-way power inlet;
a 7-way power inlet;
a 4-way power outlet;
a 7-way power outlet;
a utility power outlet; and
electrical conductors operatively connecting (a) said 4-way power inlet to said 4-way power outlet and said utility power outlet and (b) said 7-way power inlet to said 7-way power outlet and said utility power outlet.

14. The apparatus of claim 13 further including a housing carrying said 4-way power inlet, said 7-way power inlet, said 4-way power outlet, said 7-way power outlet, said utility power outlet and said electrical conductors.

15. The apparatus of claim 14, wherein said housing further includes at least one mounting tab.

16. The apparatus of claim 15, wherein said at least one mounting tab includes an aperture.

17. The apparatus of claim 16, further including a fastener for passing through said aperture and securing said apparatus to the tow vehicle.

18. The apparatus of claim 17, further including a fuse in one of said electrical conductors between said 4-way and 7-way power inlets and said utility power outlet.
